(19) United States
(12) Patent Application Publication
(10) Pub. No.: US 2011/0127256 A1
(43) Pub. Date: Jun. 2, 2011

(54) METHOD AND CIRCUIT FOR AUTOMATIC CALIBRATION OF THE POWER OF ELECTROMAGNETIC OVEN

(76) Inventors: Shouqing Qiu, Guangdong (CN); Xu Samson, Guangdong (CN); Li Peng, Guangdong (CN); Chen Jinfeng, Guangdong (CN)

(21) Appl. No.: 12/992,955

(22) PCT Filed: Dec. 9, 2009
(86) PCT No.: PCT/CN2009/001397

§ 371 Date: Nov. 16, 2010

(30) Foreign Application Priority Data
Dec. 12, 2008 (CN) 200810218351.4

(51) Int. Cl. H05B 6/04

(52) U.S. Cl. 219/660

(57) ABSTRACT

A method for automatic calibration of the power of electromagnetic oven includes the following steps: 1) selecting two current test values within a range of working current of the electromagnetic oven, making it operate in the case of the current test values and zero, detecting voltage values of current signals under the three operation states; calculating, by a CPU, a coefficient k and an intercept b according to a formula y₍ᵢ₎=k×i+b using the three sets of data, and storing them; 2) during operation, calculating, by the CPU, a current current signal i using a voltage value y₍ᵢ₎ of the current current signal detected by the current detection and collection circuit and the coefficient k and intercept b, according to a formula i=1/k×y₍ᵢ₎−b/k, and in turn calculating a current power using the current current signal and a current voltage signal. A calibration program is built in the chip for setting a parameter and automatically colleting and calculating the calibration parameter; during operation, the current or power may be automatically calibrated, which provides an accurate basis for adjusting the power of electromagnetic oven. The mode in which a conventional potentiometer is adopted for calibration may be replaced by the present invention, which results in reduction of cost and improvement of the reliability.

### FIELD OF THE INVENTION

The present invention relates to the electromagnetic oven technology, and particularly to a method and a calibration circuit for automatic calibration of the power of electromagnetic oven.

### BACKGROUND OF THE INVENTION

For a general electromagnetic oven, the calculation of the power of the electromagnetic oven is usually performed by detecting the current working voltage, the working current and calculating the current power by a formula power=voltage×current.

The current sampling circuit typically uses an instrument transformer or a constantan wire resistor to sample the current small signal, the sampled current small signal is converted into a voltage signal and then is amplified for calculation. Since a relatively big error may occur in this manner, according to the linear expression y=kx+b (k≠0), a potentiometer is to be used for adjusting, so as to correct the coefficient k in the formula. Here, a potentiometer is added. During the processes of transportation and usage, an offset of the resistance value often occurs on the potentiometer, which leads to a bigger power error of the electromagnetic oven.

In addition, the product information of a general electromagnetic oven usually shows the product model, running number, production date or bar code information in the manner of a paster on the machine or packing case, which is easy to be counterfeited, that is, a name brand may be counterfeited by simple print paste or packing process.

### SUMMARY OF THE INVENTION

In order to overcome the above mentioned calibration drawbacks presented in the existing electromagnetic oven technology, the present invention provides a method for automatic calibration of the power of electromagnetic oven and a circuit for performing the same, so as to satisfy the requirements of the electromagnetic oven with respect to the power calibration, real-time power calculation and control.

The method for automatic calibration of the power of electromagnetic oven according to the present invention includes the following steps:

1) selecting two current test values i1 and i2 within a range of working current of the electromagnetic oven, making a main loop operate in turn in the case of the current test values i1, i2 and zero, collecting current signals for each of the three operation states respectively by a current detection and collection circuit, and storing output voltage values y_{(i 1)} [symbol] y_{(i 2)} [symbol] y_{(i 0)} of the current detection and collection circuit; calculating, by a CPU, a coefficient k and an intercept b according to a formula y₍ᵢ₎=k×i+b(k≠0) using the three sets of data, and storing the coefficient k and the intercept b in a memory;

2) during operation of the electromagnetic oven, calculating, by the CPU, a current current signal i using a voltage value y₍ᵢ₎ of the current current signal detected by the current detection and collection circuit and the coefficient k and intercept b in the memory, according to a formula i=1/k×y₍ᵢ₎−b/k, and in turn calculating a current power value using the current current signal and a current voltage signal detected by a voltage detection and collection circuit.

The circuit for automatic calibration of the power of electromagnetic oven to realize the above mentioned method includes:

a current detection and collection circuit including a current sampling circuit, an amplifier and an A/D converter, the amplifier being connected between the current sampling circuit and an input terminal of the A/D converter;

a voltage detection and collection circuit including a voltage sampling circuit and the A/D converter, an output of the voltage sampling circuit being connected to another input terminal of the A/D converter;

a memory for storing a control program, an operation program and a current or power calibration parameter; and

a CPU of which an input terminal is connected to an output terminal of the A/D converter, the memory being connected to the CPU; wherein the CPU calculates the current or power calibration parameter using a predetermined current test value and a detected voltage value of a current signal, stores it in the memory and in turn performs automatic calibration on current current and current power using the calibration parameter.

The amplifier, the A/D converter, the CPU and the memory are integrated in the same chip.

In the present invention, a solution for automatic calculation of the power of electromagnetic oven is proposed firstly. In this solution, a program module for automatic calibration of the power is built in the chip. During production of the electromagnetic oven, the power or current calibration parameter is automatically colleted and calculated according to a predetermined parameter, and this calibration parameter is recorded in a memory built in the chip, the memory having the power off memory function. During operation of the electromagnetic oven, the CPU reads the calibration parameter recorded in the memory built in the chip for performing calibration on the current signal, and in turn calculates current power value with the voltage signal, which provides an accurate basis for adjusting and protection of the power of electromagnetic oven by the CPU.

The mode in which a conventional hardware potentiometer is adopted for calibration may be replaced by the present invention, which results in reduction of cost and improvement of the product reliability.

The amplifier, A/D converter, CPU within the circuit for automatic calibration of the power according to the present invention are integrated in the same chip, which results in high chip integrity and simple peripheral application circuit, such that the difficulty of production and maintenance is greatly reduced.

The product information of the electromagnetic oven is stored in the memory according to the present invention. This product information may be displayed on the digital tube or LED through key-press operation, such that the information secrecy effect is good and the difficulty of counterfeiting products is greatly increased.

### BRIEF DESCRIPTION OF THE DRAWINGS

FIG. 1 is a block diagram illustrating the principle according to the present invention;

FIG. 2 is an embodiment of the circuit diagram thereof.

### DETAILED DESCRIPTION OF THE EMBODIMENTS

The present invention will be described in detail with reference to the Figures.

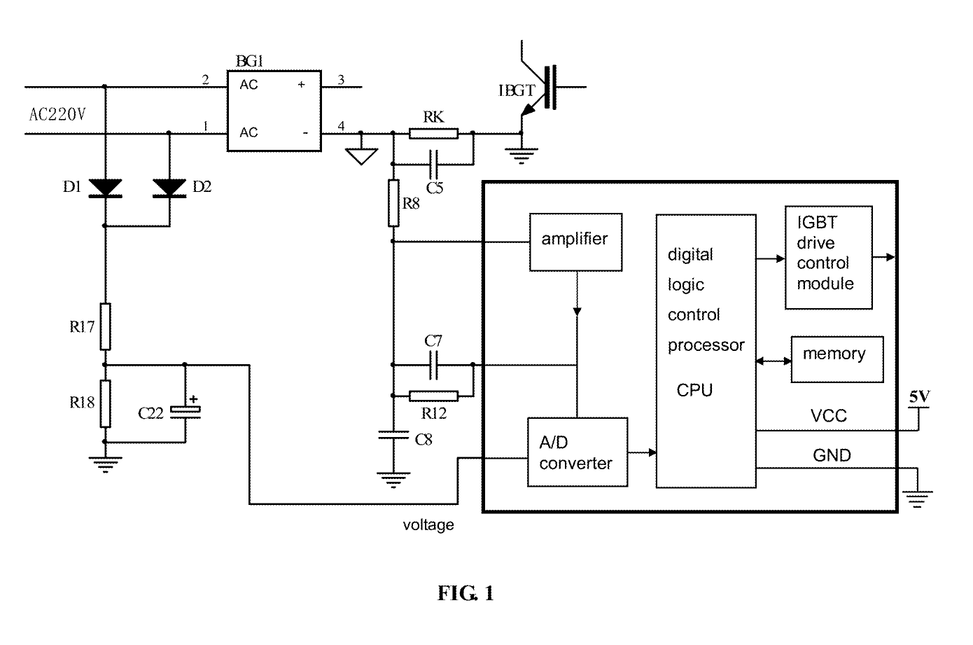

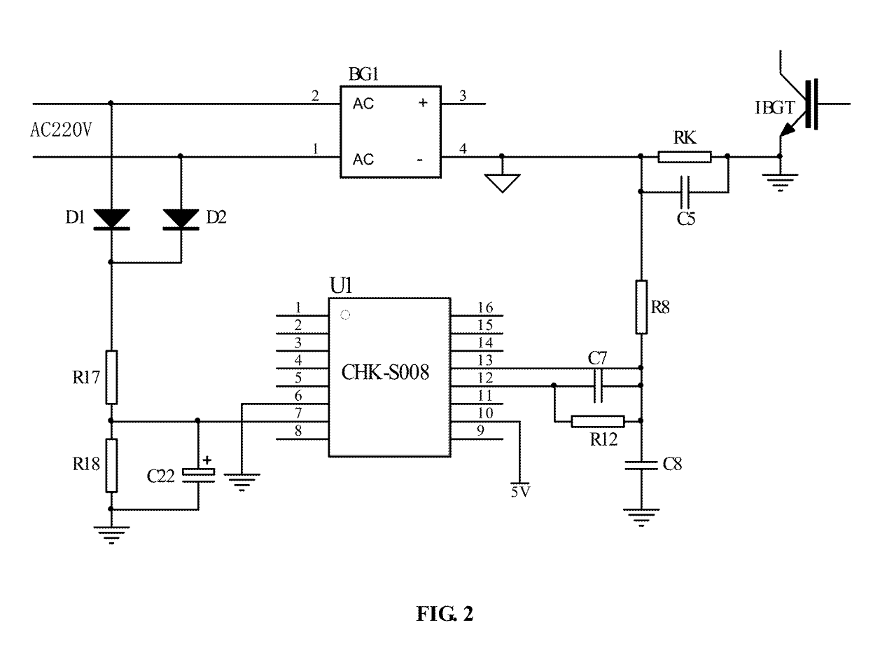

Referring to FIGS. 1 and 2, the illustrated circuit for automatic calibration of the power of electromagnetic oven mainly includes: a current detection and collection circuit, a voltage detection and collection circuit, a memory and a digital logic control processor CPU, etc.

The current detection and collection circuit includes a current sampling circuit, an amplifier and an A/D converter, the amplifier being connected between the current sampling circuit and an input terminal of the A/D converter. The current sampling circuit includes a constantan wire resistor RK that is connected in series between the rectifier bridge BGI and the drain of the IGBT and a resistor R8 that is connected to the constantan wire resistor RK. One terminal of the resistor R8 is connected to an input terminal of the amplifier (i.e., the 13 Pin of the CHK-S008 chip in FIG. 2), a feedback circuit composed of a resistor R12 and a capacitor C7 connected in parallel is connected between the input and output terminals of the amplifier (i.e., the 13 Pin and the 12 Pin of the CHK-S008 chip in FIG. 2), the input terminal of the amplifier is connected to a capacitor C8 that is grounded, and the constantan wire resistor RK1 is connected to a capacitor C5 in parallel.

The voltage detection and collection circuit includes a voltage sampling circuit and the A/D converter. The output of the voltage sampling circuit is connected to another input terminal of the A/D converter. The voltage sampling circuit includes diodes D1, D2, resistor divider R17 and R18 connected between the cathode of the diodes D1 and D2 and the ground. The anodes of the diodes D1 and D2 are connected to two AC input lines of the above rectifier bridge BGI respectively, the resistor R18 is connected to a capacitor C22 in parallel, and the public end of the resistor R17 and R18 outputs a voltage signal to another input terminal of the A/D converter (i.e., the 7 Pin of the CHK-S008 chip in FIG. 2).

An input terminal of the digital logic control processor CPU is connected to the output terminal of the A/D converter, the memory is connected to a corresponding port of the CPU, and the memory stores control and operation programs as well as a linear calibration program of a current amplifier, etc. The memory is a nonvolatile memory with the power off memory function.

The above mentioned amplifier, A/D converter, digital logic control processor CPU and the memory are integrated in a SoC (System on a Chip) chip, such as a CHK-S008 chip shown in the FIG. 2.

A current calibration parameter is stored in an area of the nonvolatile memory in the CHK-S008 chip for calibrating the power of the electromagnetic oven when a calibration program is executed by CPU. A product information memory area in the nonvolatile memory may store the product information of the electromagnetic oven, such as the information of bar code of the product, manufacturer number, running number, production date, etc. The product information may be displayed on the digital tube or LED through key-press operation so as to enhance the information secrecy effect and greatly increase the difficulty of counterfeiting products.

The method for automatic calibration of the power realized by using the above circuit for automatic calibration of the power of electromagnetic oven includes the following steps:

1) selecting two current test values i1 and i2 within a range of working current of the electromagnetic oven, making a main loop operate in turn in the case of the current test values i2 and zero, collecting current signals for each of the three operation states respectively by a current detection and collection circuit, and storing output voltage values y_{(i 1)}` y_{(i 2)}` y_{(i 0)} of the current detection and collection circuit;

calculating, by the CPU, a coefficient k and a voltage value y_{(i 0)} corresponding to a case where the current test value is equal to zero, i.e., an intercept b, according to a formula y₍ᵢ₎=k×i+b (k≠0) using the two sets of data i1, y_{(i 1)} and i2, y_{(i 2)}, and storing the coefficient k and the intercept b in the memory;

2) during operation of the electromagnetic oven, calculating, by the CPU, a current current signal i using a voltage value y₍ᵢ₎ of the current current signal detected by the current detection and collection circuit and the coefficient k and intercept b in the memory, according to a formula i=1/k×y₍ᵢ₎−b/k, and in turn calculating a current power value using the current current signal and a current voltage signal detected by the voltage detection and collection circuit.

1. A method for automatic calibration of the power of electromagnetic oven comprising:
1) selecting two current test values i1 and i2 within a range of working current of the electromagnetic oven, making a main loop operate in turn in the case of the current test values i1, i2 and zero, detecting voltage values y_{(i 1)}` y_{(i 2)}` y_{(i 0)} of current signals under the three operation states by a current detection and collection circuit; calculating, by a CPU, a coefficient k and an intercept b according to a formula y₍ᵢ₎=k×i+b (k≠0) using the three sets of data, and storing the coefficient k and the intercept b in a memory;
2) during operation of the electromagnetic oven, calculating, by the CPU, a current current signal i using a voltage value y₍ᵢ₎ of the current current signal detected by the current detection and collection circuit and the coefficient k and intercept b in the memory, according to a formula i=1/k×y₍ᵢ₎−b/k, and in turn calculating a current power value using the current current signal and a current voltage signal detected by a voltage detection and collection circuit.

2. The method for automatic calibration of the power of electromagnetic oven according to claim 1, wherein the current detection and collection circuit comprises a current sampling circuit, an amplifier and an A/D converter, the amplifier being connected between the current sampling circuit and an input terminal of the A/D converter; the voltage detection and collection circuit comprises a voltage sampling circuit and the A/D converter, the output of the voltage sampling circuit being connected to another input terminal of the A/D converter.

3. The method for automatic calibration of the power of electromagnetic oven according to claim 2, wherein
the voltage sampling circuit comprises diodes D1, D2, resistor divider R17 and R18 connected between a cathode of the diodes D1 and D2 and the ground, the anodes of the diodes D1 and D2 are connected to two AC input lines of the rectifier bridge respectively, the resistor R18 is connected to a capacitor C22 in parallel, and a public end of the resistor R17 and R18 outputs a voltage signal to the A/D converter;
the current sampling circuit comprises a constantan wire resistor RK that is connected in series between the rectifier bridge and the drain of an IGBT and a resistor R8 that is connected to the constantan wire resistor RK, the output of the current sampling circuit is connected to an input terminal of the amplifier, a feedback circuit composed of a resistor and a capacitor connected in parallel is connected between the input and output terminals of the amplifier.

4. A circuit for automatic calibration of the power of electromagnetic oven comprising:
a current detection and collection circuit comprising a current sampling circuit, an amplifier and an A/D converter, the amplifier being connected between the current sampling circuit and an input terminal of the A/D converter;
a voltage detection and collection circuit comprising a voltage sampling circuit and the A/D converter, an output of the voltage sampling circuit being connected to another input terminal of the A/D converter;
a memory for storing a control program, an operation program and a current or power calibration parameter; and
a CPU of which an input terminal is connected to an output terminal of the A/D converter, the memory being connected to the CPU; wherein the CPU calculates the current or power calibration parameter using a predetermined current test value and a detected voltage value of a current signal, stores it in the memory and in turn performs automatic calibration on current current and current power using the calibration parameter.

5. The circuit for automatic calibration of the power of electromagnetic oven according to claim 4, wherein the amplifier, the A/D converter, the CPU and the memory are integrated in the same chip.

6. The circuit for automatic calibration of the power of electromagnetic oven according to claim 4 or 5, wherein the current sampling circuit comprises a constantan wire resistor RK that is connected in series between the rectifier bridge and the drain of an IGBT and a resistor R8 that is connected to the constantan wire resistor RK, the output of the current sampling circuit is connected to an input terminal of the amplifier, a feedback circuit composed of a resistor and a capacitor connected in parallel is connected between the input and output terminals of the amplifier.

7. The circuit for automatic calibration of the power of electromagnetic oven according to claim 6, wherein the voltage sampling circuit comprises diodes D1, D2, resistor divider R17 and R18 connected between a cathode of the diodes D1 and D2 and the ground, the anodes of the diodes D1 and D2 are connected to two AC input lines of the rectifier bridge respectively, the resistor R18 is connected to a capacitor C22 in parallel, and a public end of the resistor R17 and R18 outputs a voltage signal to the A/D converter.

8. The circuit for automatic calibration of the power of electromagnetic oven according to claim 4 or 5, wherein the voltage sampling circuit comprises diodes D1, D2, resistor divider R17 and R18 connected between a cathode of the diodes D1 and D2 and the ground, the anodes of the diodes D1 and D2 are connected to two AC input lines of the rectifier bridge respectively, the resistor R18 is connected to a capacitor C22 in parallel, and a public end of the resistor R17 and R18 outputs a voltage signal to the A/D converter.

9. The circuit for automatic calibration of the power of electromagnetic oven according to claim 4 or 5, wherein the memory is a nonvolatile memory.

10. The circuit for automatic calibration of the power of electromagnetic oven according to claim 4 or 5, wherein a product information memory area in the memory stores product information of the electromagnetic oven.
